(19) United States
(12) Patent Application Publication
(10) Pub. No.: US 2013/0055378 A1
(43) Pub. Date: Feb. 28, 2013

(54) METHOD AND PORTABLE DEVICE FOR CONTROLLING PERMISSION SETTINGS FOR APPLICATION

(71) Applicants: Youn-Joo CHANG, Seoul (KR); Mi-Seon KIM, Incheon-si (KR); Hong-Mee AHN, Seoul (KR)

(72) Inventors: Youn-Joo CHANG, Seoul (KR); Mi-Seon KIM, Incheon-si (KR); Hong-Mee AHN, Seoul (KR)

(73) Assignee: PANTECH CO., LTD., Seoul (KR)

(21) Appl. No.: 13/490,838

(22) Filed: Jun. 7, 2012

(30) Foreign Application Priority Data
Aug. 29, 2011 (KR) 10-2011-0086859

(51) Int. Cl. G06F 21/00

(52) U.S. Cl. 726/17

(57) ABSTRACT

A method for controlling permissions of a portable device includes selecting an access control mode for an application, the access control mode being associated with one or more permissions to manage resources of the portable device, executing the application in the access control mode, and controlling the one or more permissions for the application according to the access control mode. A portable device to control permissions includes a mode setting unit to select an access control mode for an application, the access control mode being associated with one or more permissions to manage resources of the portable device, an execution unit to execute the application in the access control mode, and an access control unit to control the one or more permissions for the application according to the access control mode.

### CROSS-REFERENCE TO RELATED APPLICATION

This application claims priority from and the benefit under 35 U.S.C. §119(a) of Korean Patent Application No. 10-2011-0086859, filed on Aug. 29, 2011, which is hereby incorporated by reference for all purposes as if fully set forth herein.

### BACKGROUND

1. Field

The following description relates to a method and portable device for controlling permission settings for an application, and more particularly, to a method and portable multifunction device for establishing and managing settings for permissions for an application to access secured resources.

2. Discussion of the Background

Portable device (hereinafter, it may be referred to as a ‘device’), such as a smartphone, a smart pad, a personal digital assistant (PDA), a tablet computer, and the like, may be used by a single user, and the usage characteristics, user's personal information, and the mobility information of the device of the single user may be personalized and be stored by the portable device. In addition, the portable device may be different from the desktop computer, since personal information of the user is often registered for subscribing to communication services using the portable device.

The portable device may use personal information and financial information of a user in mobile commerce services, and thus enhanced security for the personal information and financial information of the user may be considered by consumers. As evolved portable devices embedding an operating system similar to that of a desktop computer has emerged, demands for enhanced security for the portable devices have increased. However, due to different features of the portable devices, the security and safety of the device may not be maintained by the same method used for the desktop computer.

Further, current portable devices lack security-related information to be provided to a user. For example, Android operating system (OS) simply provides a general list of system resources in use. Thus, it may not be easy for a user to determine security risks of an application. Moreover, the user may not be clearly informed of types of personal information which may be used inappropriately by the application. Further, an importance level of each item using the system resources may not be shown to the user.

### SUMMARY

Exemplary embodiments of the present invention provide a method and portable device for controlling permission settings for an application to access secured resources.

Additional features of the invention will be set forth in the description which follows, and in part will be apparent from the description, or may be learned by practice of the invention.

An exemplary embodiment of the present invention provides a portable device to control permissions, including a mode setting unit to select an access control mode for an application, the access control mode being associated with one or more permissions to manage resources of the portable device; an execution unit to execute the application in the access control mode; and an access control unit to control the one or more permissions for the application according to the access control mode.

An exemplary embodiment of the present invention provides a method for controlling permissions of a portable device, including selecting an access control mode for an application, the access control mode being associated with one or more permissions to manage resources of the portable device; executing the application in the access control mode; and controlling the one or more permissions for the application according to the access control mode.

An exemplary embodiment of the present invention provides a method for controlling permissions of a portable device, including requesting a permission to install an application; installing the application; displaying one or more access restriction modes during installing the application; receiving an input to select an access restriction mode; and modifying a permission setting according to the access restriction mode.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic diagram illustrating a portable device to control permissions for an application according to an exemplary embodiment of the present invention.

FIG. 2 is a diagram illustrating a method for grouping application-related permissions according to various modes according to an exemplary embodiment of the present invention.

FIG. 3A and FIG. 3B are tables showing permissions of each access restriction mode according to an exemplary embodiment of the present invention.

FIG. 4 is a diagram illustrating a list of access restriction modes for an application according to an exemplary embodiment of the present invention.

FIG. 5 is a diagram illustrating a list of access restriction modes for an application according to an exemplary embodiment of the present invention.

FIG. 6 is a flowchart illustrating a method for controlling application access permissions according to an exemplary embodiment of the present invention.

FIG. 7 is a flowchart illustrating a method for allowing a user to select and input permission modes during installing an application in a device according to an exemplary embodiment of the present invention.

FIG. 8A and FIG. 8B are diagrams illustrating a portable device to control permissions for an application according to an exemplary embodiment of the present invention.

FIG. 9 is a diagram illustrating a portable device to control permissions based on time, location information or device state information according to an exemplary embodiment of the present invention.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It will be understood that for the purposes of this disclosure, “at least one of” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, XZZ, YZ, X).

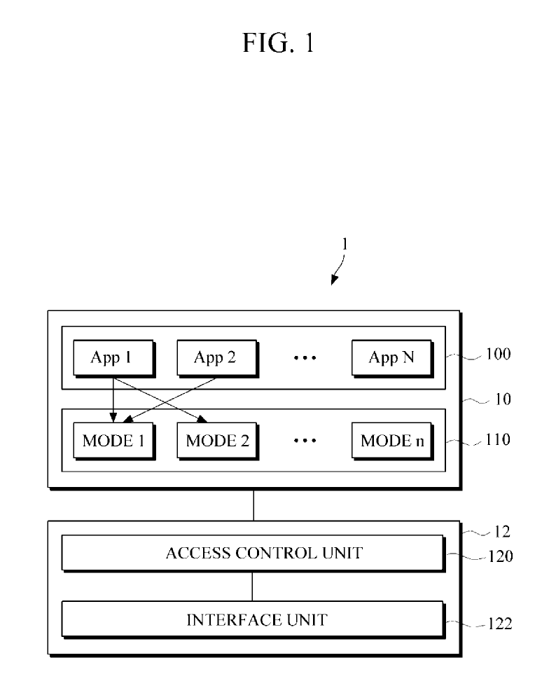

FIG. 1 is a schematic diagram illustrating a portable device to control permissions for an application according to an exemplary embodiment of the present invention.

Portable device 1 (hereinafter, it may be referred to as a “device”) may provide general communicating device operations and computer-supported operations including Internet communication and data search through wireless Internet connections. The device 1 may be a smartphone or a Smart Pad, or any present and future device having similar functions as a smartphone.

Referring to FIG. 1, the device 1 includes an application domain 10 and a framework domain 12. When an application in the application domain 10 is executed, a corresponding operation may be performed via the framework domain 12. The framework domain 12 may provide a basic architecture that constitutes a system. The framework domain 12 may include an interface and services and may provide the interface to applications. The service may perform a function requested through the interface. The services may include a package manager service, an activity manager service, a window manager service, a telephony manager service, a location manager service, a notification manager service, and the like. Further, the framework domain 12 may include a storage unit (not shown) to manage an application list and permission lists for each application according to access control modes. Access control modes may be referred to as access restriction modes when the access control modes include at least one restriction mode. Permissions may refer to access rights to specific resources and secured information of the portable device, such as system files, Wi-Fi connection, 3G data connection, account, banking information, and the like. Further, the portable device 1 may include an execution unit to execute an application in an access control mode according to the selection of the access control mode by a user or a device state.

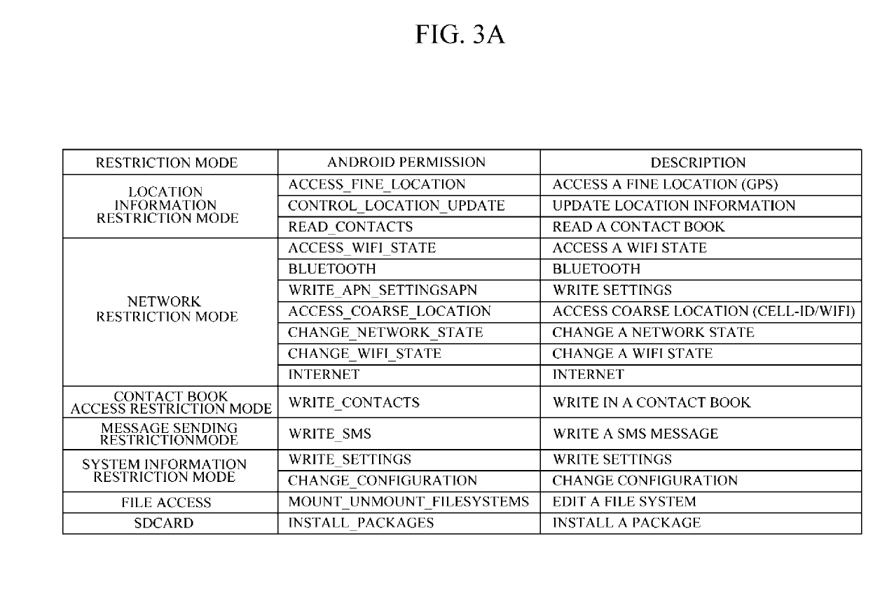

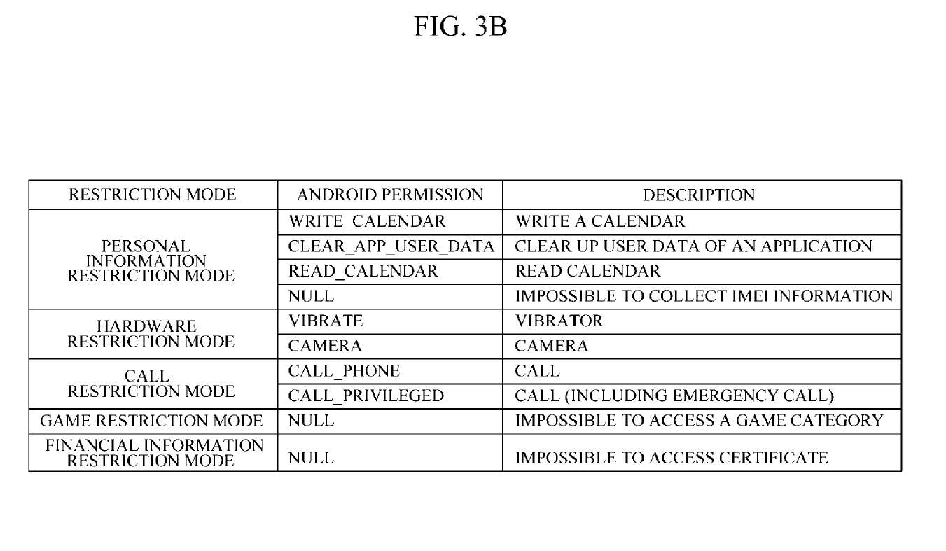

The application domain 10 may include multiple applications 100 (App 1, App 2, and App n), and a mode setting unit 110. The mode setting unit 110 may classify permissions related to applications into groups according to various access control modes (for example, Mode 1, Mode 2, . . . , Mode n). Permissions related to authorization requested by the application will be described later with reference to FIG. 3A and FIG. 3B.

The mode setting unit 110 may selectively apply access restriction modes, for example, Mode 1, Mode 2, and Mode N, to each of the applications 100, for example, App 1, App 2, and App n. For example, as shown in FIG. 1, App 1 may support Mode 1 and Mode 2, and App 2 may support Mode 1. The mode setting unit 110 may restrict access to secured resources by one or more applications among the applications 100 (App 1, App 2, . . . , App n) based on an access restriction mode among various access restriction modes (Mode 1, Mode 2, . . . , Mode n).

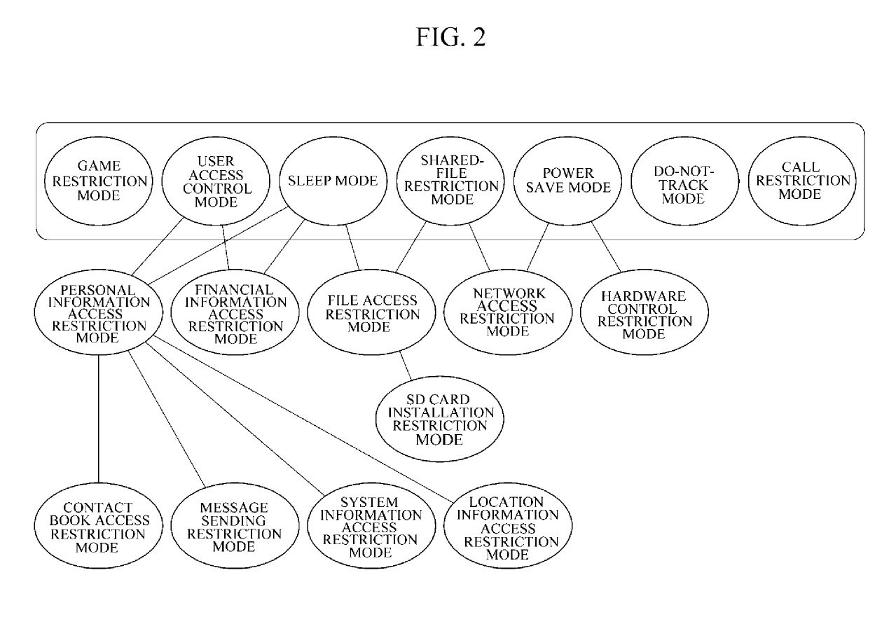

The mode setting unit 110 may extract permission information from at least one of applications installed in the portable device, and classify the extracted permission information into groups according to at least one of access control modes, i.e., game restriction mode, user access control mode, sleep mode, shared-file restriction mode, power save mode, do-not-track mode, call restriction mode, or the like. Further, the mode setting unit 110 may hierarchically categorize the permissions related to applications into groups. Specifically, as shown in FIG. 2, access control modes may include multiple sub-modes, such as a personal information access restriction mode, a financial information access restriction mode, a file access restriction mode, a network access restriction mode, and a hardware control restriction mode, and the like. Further, the multiple sub-modes may be associated with a group of permissions. For example, the network access restriction mode may control network-related permissions such as Wi-Fi access, Bluetooth, Internet access, change of Wi-Fi state, and the like. Accordingly, the permissions or sub-modes associated with different applications may be redundantly included in the same access restriction mode. The operation of the mode setting unit 110 which may perform grouping of access restriction modes will be described in more detail below with reference to FIG. 2.

The framework domain 12 may control each application 100 (App 1, App 2, . . . , App n) and corresponding permissions. The framework domain 12 may include an access control unit 120 and an interface unit 122. The access control unit 120 may control an external access to an application on the basis of a group of access restriction modes by restricting or allowing the occurrence of a permission event which is included in the access restriction mode. The interface unit 122 may output the groups of access restriction modes in a display and receive a user's input to select a user permission setting for the access restriction mode. The access control unit 120 may control external access to the device, or restrict information leakage from the device according to the permission event. The permission event may refer to an event whereby the access control unit 120 determines whether to grant or deny permission for some action to occur.

The access control unit 120 may control the interface unit 122 to display a list of access restriction modes for each application or a list of applications for each access control mode during installing or executing an application. Further, the access control unit 120 may control the interface unit 122, thereby allowing the user to select the user permission setting for the access restriction mode. In response to the user's selection of user permission setting, the access control unit 120 may control an external access to the device or information leakage from the device by restricting or permitting the occurrence of a permission event according to a corresponding access control mode.

Further, the access control unit 120 may search for an access restriction mode related to a permission or permission setting requested by an application from groups of access restriction modes during the installation or an execution of the application, and control the interface unit 122 to display one or more searched access restriction modes. The access control unit 120 may control the interface unit 122, thereby allowing the user to select and input a user permission setting for the access restriction mode. The access control unit 120 may restrict or allow the occurrence of a permission event of the access restriction mode based on the user's selection of the permission setting.

As a result of a permission event, the access control unit 120 may provide resources or data to an application once permission for the application to access the resources or the data is allowed. If access permission is denied as a result of the permission event, a value of NULL may be returned, the application may be terminated, or a warning signal may be notified.

FIG. 2 is a diagram illustrating a method for grouping application-related permissions according to various modes according to an exemplary embodiment of the present invention.

Referring to FIG. 2, access control modes may be classified into game restriction mode, user access control mode, sleep mode, shared-file restriction mode, power save mode, do-not-track mode, and call restriction mode.

Game restriction mode is to control the execution of files (for example, APK files of Android system) in association with a game category (i.e., game category of the Android Market or App Store). Sleep mode as safe mode is to restrict an access when the device is not in use for a certain period of time, such as when the user is sleeping. The sleep mode may include access restriction function with respect to permissions related to financial information access, file access, and SD card installation.

User access control mode is to restrict another user from executing a secured application in the device. The user access control mode may include personal information access restriction mode and financial information access restriction mode. If the personal information access restriction mode is activated by the user, no application is allowed to access personal information. The personal information access restriction mode may restrict access to permissions related to address book access restriction, message sending restriction, system information access restriction, and location information access restriction.

The shared file restriction mode is to prevent a leakage of a file by restricting an access to the file. The shared file restriction mode may control access to permissions related to file access restriction, network access restriction, and SD card installation restriction. The power save mode is to control operations of the device that cause higher battery consumption. The power save mode may restrict access to permissions related to network access restriction and hardware control restriction.

The do-not-track mode is to control the provision of location information of the portable device. The do-not-track mode restricts access to permission related to location information, such as global positioning system (GPS) information. The call control mode is to control call operations such as voice call, video call, and the like. The exemplary embodiments described herein with reference to FIG. 2 are provided for better understanding of the present invention, and it should be appreciated that the configuration of security information for grouping may vary.

FIG. 3A and FIG. 3B are tables showing permissions of each access restriction mode according to an exemplary embodiment of the present invention.

Referring to FIG. 3A and FIG. 3B, each of the permissions may be requested by an application. The permissions may be classified into groups based on access restriction mode as shown in FIG. 3A and FIG. 3B. The exemplary embodiments shown in FIG. 3A and FIG. 3B are provided for better understanding of the present invention, and it should be appreciated that types and ranges of the access restriction modes and permissions may vary.

For example, if the portable device has an Android-based operating system, location-related permissions, such as ACCESS_FINE_LOCATION, CONTROL_LOCATION_UPDATE, and READ_CONTACTS, may be managed in location information restriction mode. In network access restriction mode, network-related permissions, such as ACCESS_WIFI_STATE, BLUETOOTH, WRITE_APN_SETTINGSAPN, ACCESS COARSE_LOCATION, CHANGE_NETWORK_STATE, CHANGE_WIFI_STATE, and INTERNET, may be managed. In contact book access restriction mode, contact information-related permissions, such as WRITE_CONTACTS, may be managed. In message sending restriction mode, message-related permissions, such as WRITE_SMS, may be managed. In system information restriction mode, system information-related permissions, such as WRITE_SETTINGS, and CHANGE_CONFIGURATION, may be managed. In file access restriction mode, file system-related permissions, such as MOUNT_UNMOUNT_FILESYSTEMS, may be managed. In SD card restriction mode, SD card access-related permissions, such as INSTALL_PACKAGES, may be managed.

In personal information restriction mode, personal information-related permissions, such as WRITE_CALENDAR, CLEAR_APP_USER_DATA, an READ_CALENDAR, may be managed. In hardware control restriction mode, hardware operation-related permissions, such as VIBRATE, and CAMERA, may be managed. In call restriction mode, call-related permissions, such as CALL_PHONE, and CALL_PRIVILEGED, may be managed.

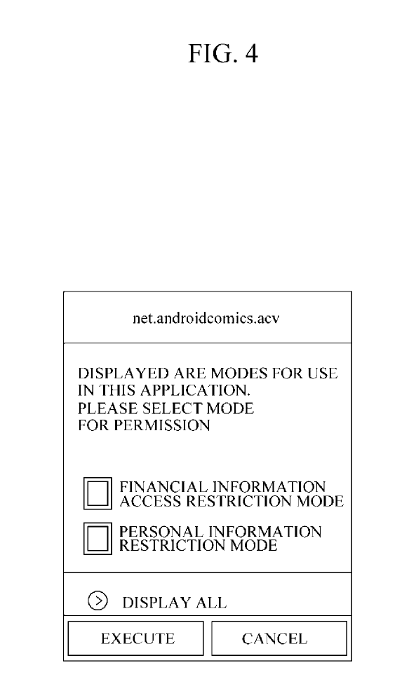

FIG. 4 is a diagram illustrating a list of access restriction modes for an application according to an exemplary embodiment of the present invention.

For a portable device capable of installing various applications, permissions offered during installing an application may be confusing for a user to understand. Thus, it may be difficult for the user to make a decision for selecting specific permission settings for the application during installing or deleting the application. For example, the android comic viewer (ACV) of the Android OS for reading a comic book or a magazine may provide a user interface during installation for the user to select permissions to be allowed to the application with respect to, for example, storage (modify/delete SD card contents), network communication (full Internet access), and the like. In this case, the user may become confused during installing or deleting the application due to the complicated security information or insufficient security information.

Thus, as shown in FIG. 4, access restriction modes which include grouped permissions together to make pieces of permission information more understandable may be provided. For example, as shown in FIG. 4, the ACV application may provide personal information access restriction mode, financial information access restriction mode, and the like, which may be easier for the user to understand. Accordingly, the user may select one or more access restriction modes for setting the permission settings for the application. Thus, an application may be executed in different modes according to user's selection. Certain operations of the application may be restricted by selected mode, since the selected mode may not allow an access to resources related to the certain operations.

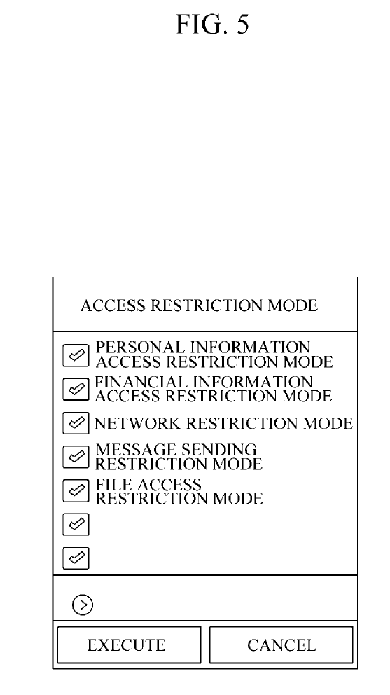

FIG. 5 is a diagram illustrating a list of access restriction modes for an application according to an exemplary embodiment of the present invention.

A list of applications per an access restriction mode may be provided upon executing an application of a device. Further, a list of access restriction modes that can be applied for an application may be provided. For example, as shown in FIG. 5, a list of access restriction modes for an application, such as personal information access restriction mode, financial information access restriction mode, network access restriction mode, message sending restriction mode, and file access restriction mode, may be displayed on a display. The user may determine whether to apply an access restriction mode for the application. Multiple access restriction modes may be applied to an application.

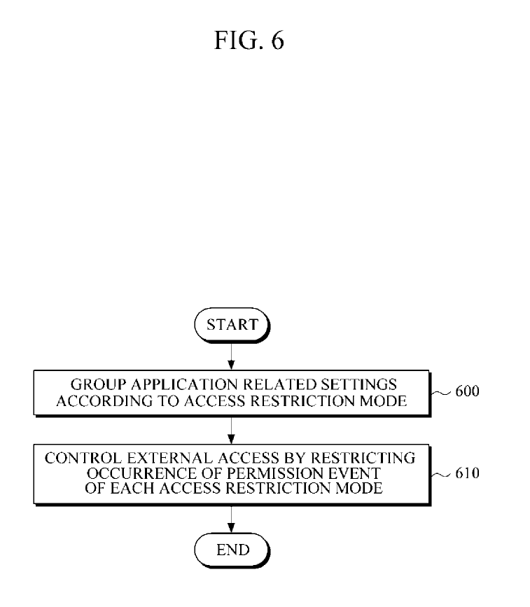

FIG. 6 is a flowchart illustrating a method for controlling application access permissions according to an exemplary embodiment of the present invention. FIG. 6 will be described as if performed by portable device 1 shown in FIG. 1, but is not limited as such.

Referring to FIG. 6, the device 1 may extract pieces of permission information from at least one of installed applications and groups the pieces of the permission information according to an access restriction mode in operation 600. The device 1 may group the permission information according to at least one of access restriction modes including game restriction mode, user access control mode, sleep mode, shared-file restriction mode, power save mode, do-not-track mode, and call restriction mode.

Further, the device 1 may restrict or allow the occurrence of a permission event included in each access restriction mode to control the access from outside of the device 1 or leakage of information with respect to the permission information of the access restriction mode in operation 610.

For example, the device 1 may display a list of access restriction modes of each application or a list of applications of each access restriction mode during installing or executing an application. Further, the user may select a user permission associated with the access restriction mode. In response to the user's selection of the user permission, the device 1 may restrict or allow the occurrence of a permission event of the corresponding access restriction mode.

Further, the device 1 may search for an access restriction mode related to a permission requested by an application during installation or execution of the application from groups of access restriction modes, and display searched access restriction modes. Then, the user may select a user permission setting for the access restriction mode and input the selection. If the application was previously installed, the user may have already selected the permission setting, in which case the step of the user selecting user permission setting may be omitted during the application execution as described here. If the permission for the application is allowed in response to the user's selection or a pre-set permission setting, resource or data requested by the application may be provided according to the permission setting, and if the permission is denied, a value of NULL may be returned, the application may be terminated, or a warning signal may be notified.

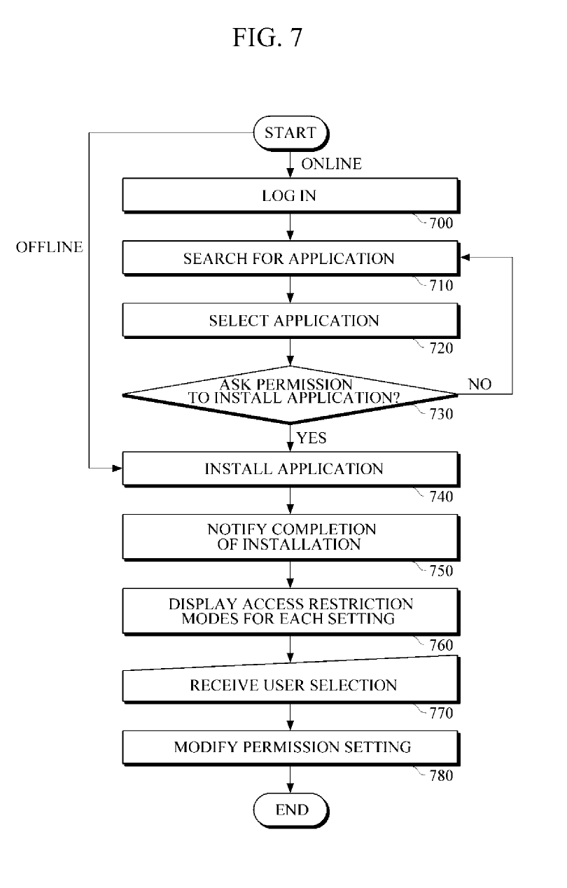

FIG. 7 is a flowchart illustrating a method for allowing a user to select and input permission modes during installing an application in a device according to an exemplary embodiment of the present invention. FIG. 7 will be described as if performed by portable device 1 shown in FIG. 1, but is not limited as such.

Referring to FIG. 1 and FIG. 7, a user may log in online in operation 700 and search for an application in operation 710. In response to the user's selection of an application in operation 720, the device 1 may request permissions in operation 730. Then, the user may install the application in operation 740, and the device 1 may notify the completion of application installation in operation 750.

The device 1 may search for an access restriction mode based on permissions requested by the application, and display searched access restriction mode in operation 760. The user may select and input a user permission setting for the searched access restriction mode in operation 770. The user may modify a permission setting for an access restriction mode for permissions requested by the application in operation 780.

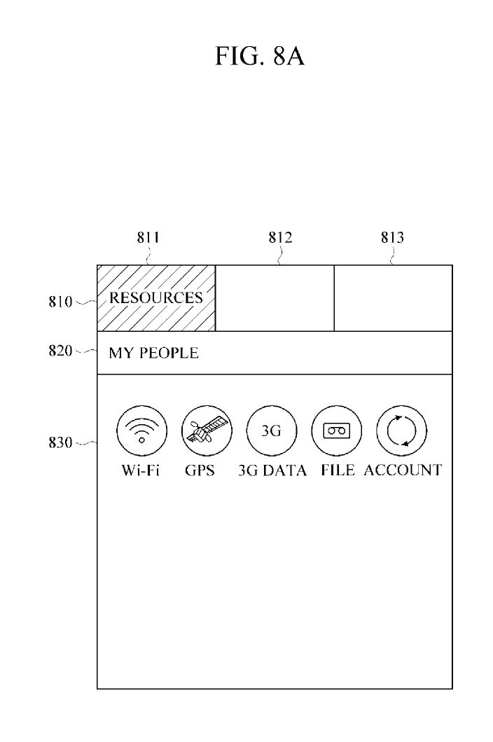

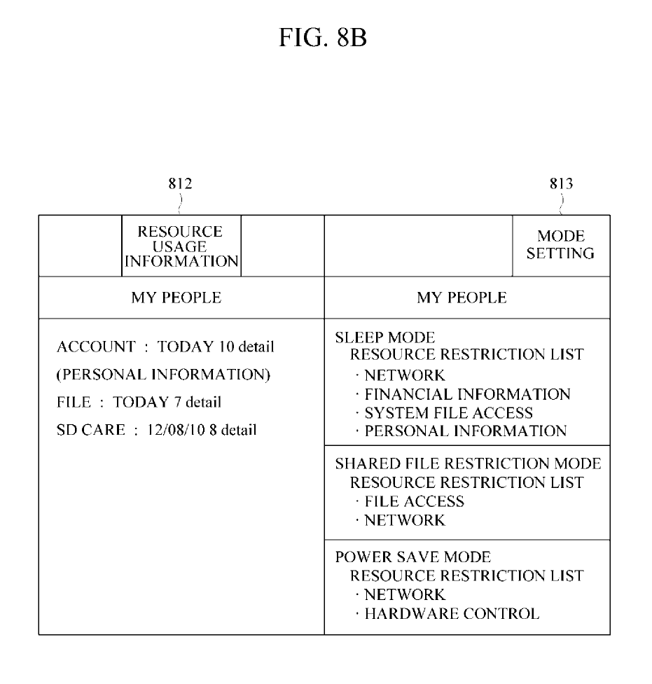

FIG. 8A and FIG. 8B are diagrams illustrating a portable device to control permissions for an application according to an exemplary embodiment of the present invention.

Referring to FIG. 8A, the portable device may display permission control information for an application on a display. The permission control information may include selection tabs, application information, and permission information. As shown in FIG. 8, selection tabs 810, application information 820, and permission information 830 may be displayed. If a tab 811 (resources tab) among multiple selection tabs 810 is selected by a user, resources allowed for the application ‘MY PEOPLE’ may be displayed as permission information.

Referring to FIG. 8B, if a tab 812 (resource usage information tab) is selected by a user, resource usage information may be displayed. For example, a type of resource, usage time of the resource, usage frequency of the resource may be displayed. If a tab 813 (mode setting) is selected by a user, various access control mode for the application may be displayed, such as a sleep mode, a shared file restriction mode, and a power save mode, or the like. Further, resource restriction list for each of the access control mode may be displayed along with the access control modes. Thus, the user may recognize resources that may be protected for a selected access control mode. If an application supports multiple access control modes for an execution, one or more access control modes may be selected. For example, if the shared file restriction mode and the power save mode are selected for an execution of the application ‘MY PEOPLE’, the resources listed in the resource restriction list of the shared file restriction mode and the power save mode (i.e., ‘file access’, ‘network’, and ‘hardware control’) may not be permitted for the application ‘MY PEOPLE’.

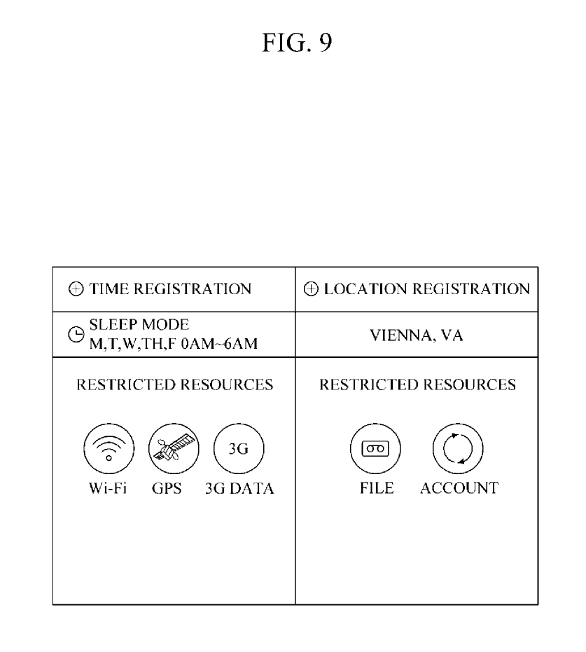

FIG. 9 is a diagram illustrating a portable device to control permissions based on time, location information or device state information according to an exemplary embodiment of the present invention.

Referring to FIG. 9, time information may be registered to control permissions to access resources. For example, sleep mode may be determined by time information registered based on time information of a usage pattern of the portable device or an input of the user. According to the registered time information, one or more resources may be restricted. For example, Wi-Fi, GPS, and 3G data communication operations may not be permitted in sleep mode. Further, location information may be registered to control permissions to access resources. For example, residence information or office location information may be registered based on location information of a usage pattern of the portable device or an input of the user. As shown in FIG. 9, File access, and account access may not be permitted if the portable device is located in Vienna, Va. Further, device state information may be registered to control permissions to access resources. For example, device state information (i.e., an application is running in background operation; an application short-cut icon does not exist; the display of the portable device is turned-off) may be used to control permissions to access resources.

According to exemplary embodiments of the present invention, a user may understand better the information related to security of an application. Since the security-related information is classified into groups, and the groups of information are provided to a user, the user may understand the security-related information. Since many users do not have knowledge on system terminologies (for example, IMEI), the users may not recognize a potential security threat that may occur when using security-related resource. However, according to the exemplary embodiments of the present invention, even in absence of knowledge of system terminologies or security-related resources, the user may set permissions using security-related information which is classified into groups or access restriction modes, and thus the security-related information including personal data may be prevented from being leaked.

Further, the portable device may assist the user evaluate the security risk in installing and deleting an application from an untrusted source. Because device applications are generally created by individual developers, they may be much less reliable in comparison with computer applications. However, preventing installation or execution of all device applications that use system information may lead to inconvenience to the user.

According to the exemplary embodiments of the present invention, the user may search for an access restriction mode from groups of access restriction modes that are classified, and modify permission settings for each access restriction mode. Therefore, the user may be able to recognize a potential security risk of each application, and may decide which application to be installed, executed, or deleted.

Moreover, while the device is not in use, an external access to the security-related information containing important personal data may be prevented to avoid information leakage, and applications may be prevented from accessing resources.

Furthermore, an application may be prevented from accessing system information from a background due to malicious code, since the device may have a risk that may not be recognized by a user. For example, if a malicious developer designs an application such that an application shortcut icon is hidden, the user of the device may not be aware of the presence of the application after installation. However, according to the present invention, permissions to access resource may be set for each application, and thus an access to resources by a malicious user may be prevented.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A portable device to control permissions, comprising:
a mode setting unit to select an access control mode for an application, the access control mode being associated with one or more permissions to manage resources of the portable device;
an execution unit to execute the application in the access control mode; and
an access control unit to control the one or more permissions for the application according to the access control mode.

2. The portable device of claim 1, wherein the mode setting unit sets one or more restricted permissions for the application according to the access control mode, and
the access control unit restricts an access to a resource corresponding to the one or more restricted permissions if the application is being executed in the access control mode.

3. The portable device of claim 1, further comprising a storage unit to store an application list for the access control mode or a list of access control modes for the application.

4. The portable device of claim 1, further comprising a storage unit to store a permission list corresponding to the access control mode, the permission list comprising an allowed permission list or a restricted permission list.

5. The portable device of claim 4, further comprising an interface unit to display the permission list and to provide an interface to set or modify the permission list.

6. The portable device of claim 1, further comprising an interface unit to display a list comprising multiple access control modes and permission lists, the permission lists being displayed in association with corresponding access control modes.

7. The portable device of claim 1, wherein the access control mode comprises at least one of a game restriction mode, a user access control mode, a sleep mode, a shared-file restriction mode, a power save mode, a do-not-track mode, and a call restriction mode.

8. The portable device of claim 1, wherein the access control mode comprises at least one sub-mode, the sub-mode being associated with a classified group of permissions.

9. The portable device of claim 8, wherein the sub-mode comprises at least one of a personal information access restriction mode, a financial information access restriction mode, a file access restriction mode, a network access restriction mode, a hardware control restriction mode, an SD card installation restriction mode, a contact book access restriction mode, a message sending restriction modes, a system information access restriction mode, and a location information access restriction mode.

10. The portable device of claim 1, wherein the access control mode is determined based on at least one of time information, location information of the portable device, and device state information.

11. A method for controlling permissions of a portable device, comprising:
selecting an access control mode for an application, the access control mode being associated with one or more permissions to manage resources of the portable device;
executing the application in the access control mode; and
controlling the one or more permissions for the application according to the access control mode.

12. The method of claim 11, further comprising:
setting one or more restricted permissions for the application according to the access control mode; and
restricting an access to a resource corresponding to the one or more restricted permissions if the application is being executed in the access control mode.

13. The method of claim 11, further comprising storing an application list for the access control mode or a list of access control modes for the application.

14. The method of claim 11, further comprising storing a permission list corresponding to the access control mode, the permission list comprising an allowed permission list or a restricted permission list.

15. The method of claim 14, further comprising displaying the permission list and providing an interface to set or modify the permission list.

16. The method of claim 11, further comprising displaying a list comprising multiple access control modes and permission lists, the permission lists being displayed in association with corresponding access control modes.

17. The method of claim 11, wherein the access control mode comprises at least one of a game restriction mode, a user access control mode, a sleep mode, a shared-file restriction mode, a power save mode, a do-not-track mode, and a call restriction mode.

18. The method of claim 11, wherein the access control mode comprises at least one sub-mode, the sub-mode being associated with a classified group of permissions.

19. The method of claim 18, wherein the sub-mode comprises at least one of a personal information access restriction mode, a financial information access restriction mode, a file access restriction mode, a network access restriction mode, a hardware control restriction mode, an SD card installation restriction mode, a contact book access restriction mode, a message sending restriction modes, a system information access restriction mode, and a location information access restriction mode.

20. The method of claim 11, wherein the access control mode is determined based on at least one of time information, location information of the portable device, and device state information.

21. A method for controlling permissions of a portable device, comprising:
requesting a permission to install an application;
installing the application;
displaying one or more access restriction modes during installing the application;
receiving an input to select an access restriction mode; and
modifying a permission setting according to the access restriction mode.
